(19) United States
(12) Patent Application Publication
(10) Pub. No.: US 2004/0164192 A1
(43) Pub. Date: Aug. 26, 2004

(54) Cover structure for main case of shredder

(76) Inventor: Frank Chang, SanChung City (TW)

Correspondence Address: DENNISON, SCHULTZ DOUGHERTY MACDONALD, 1727 KING STREET, SUITE 105, ALEXANDRIA, VA, 22314, US

(21) Appl. No.: 10/369,651

(22) Filed: Feb. 21, 2003

(51) Int. Cl. B02C 18/16

(52) U.S. Cl. 241/100; 241/285.1

(57) ABSTRACT

This invention relates to a cover structure for a main case of a shredder that comprises plastic injection molded lower box and an plastic injection molded upper cover board, wherein the lower box includes a plurality of grooves and pegs for encasing a mechanical core, including a motor, a gear assembly, cutters, a feeding switch and an auto/off/rev switch AORS. A latitudinal perimeter of the lower box defines a plurality of locating holes, and a turning part joining a handle part and a longitudinal perimeter of lower box includes a larger area locating groove. A latitudinal perimeter of the upper cover board includes barbed fasteners protruding downward from locations where the locating holes of the lower box are provided. The upper cover board includes a barbed retaining tab protruding downward from a location corresponding to where the locating groove of the lower box is provided. The upper cover board can be fixed to the lower box by a convenient covering manner by engaging the fasteners and retaining tab of the upper cover board with the locating holes and locating groove of the lower box.

### FILED OF THE INVENTION

This invention relates to a cover structure for a main case of a shredder, especially to an upper cover board and lower box of a shredder that are fixed together to a cover style so as to simplify the assembly of the shredder and that is convenient to maintain.

### BACKGROUND OF THE INVENTION

A conventional main case of shredder, as shown in FIG. 1 of U.S. Pat. No. 5,511,732 or FIG. 2 of U.S. Pat. No. 5,984,215, each comprises an upper box and a lower box. The mechanical cutter member of the shredder having a generic name of a machinery core, comprises two parallel cutters, a drive gear cluster for providing rotaion power to cutters and a motor for providing power. The machinery core is fixed to the lower box and the upper box is then covered over and fixed to the lower box with screws.

The way adopted for assembling a machinery core of the conventional shredder where the machery core is fixed to the lower box, and the upper box is then covered over and fixed to the lower box with screws, fail to meet the needs of producting produce individual parts independently for later assembly of finished products. The reason for such failure is the high inter-relationship required between the upper, lower box of shredder and the machinery core, such that the machinery core can not be combined and made into modular structure. As such, the process for assembling the finished products is complicate and the cost of products can hardly be reduced. In addition, the way adopted for assembling style of fixing the upper and lower box of the conventional by screws invovles the disadvantage of not being easily maintained.

### SUMMARY OF THE INVENTION

To overcome the disadvantages of assembly found in conventional shredders, the inventor invented a cover structure for a main case of a shredder through long time study and test.

The main object of this invention is to provide a cover structure for a main case of a shredder, which combines a machinery core of shredder into a single module. The modular core is directly placed in the injection molded, plastic lower box of the shredder, and The injection molded, plastic upper cover board is then fixed to the lower box to simplify the assembly process and reduce the cost.

The second object of this invention is to provide a cover structure for a main case of a shredder, where the upper cover board is engaged to the lower box, such that when parts needed to be maintained or changed the whole modular molding machinery core can be accessed by disengaging the upper cover board from where the upper cover board engages the lower box.

### BRIEF DESCRIPTION OF THE DRAWINGS

FIG. 1 is a perspective view showing a stripe-cut shredder disclosed in U.S. Pat. No. 5,511,732;

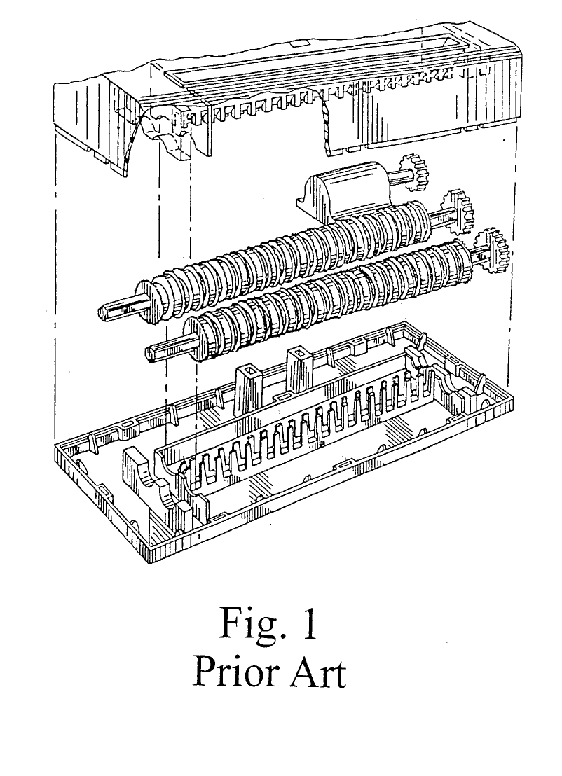

FIG. 2 is a perspective view showing a cross-cut shredder disclosed in U.S. Pat. No. 5,984,215;

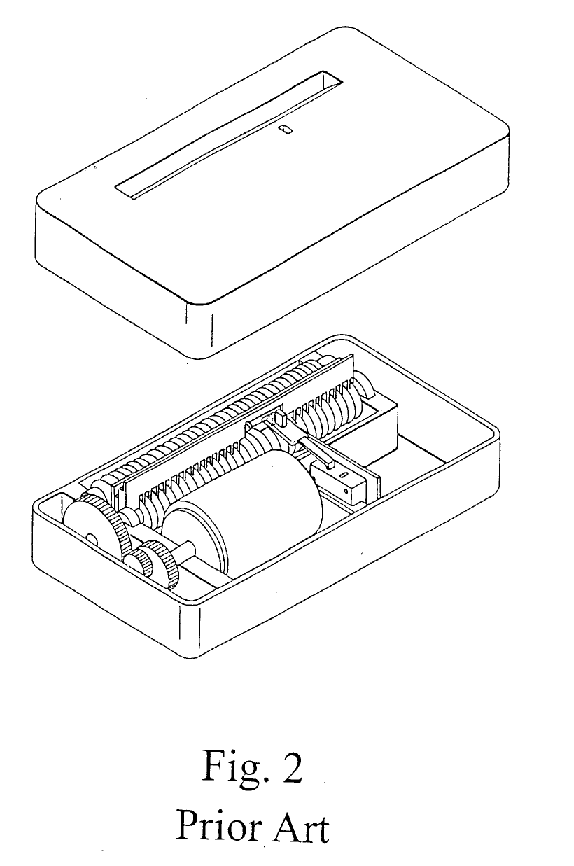

FIG. 3 is an exploded, perspective view of a first embodiment of this invention;

FIG. 4 is an exploded, perspective view of a second embodiment of this invention;

FIG. 5 is an exploded, perspective view showing the second embodiment of this invention from another side.

### DESCRIPTION OF THE PREFERRED EMBODIMENTS

This invention will now be described in further details hereinafter, with reference to the accompanying drawings.

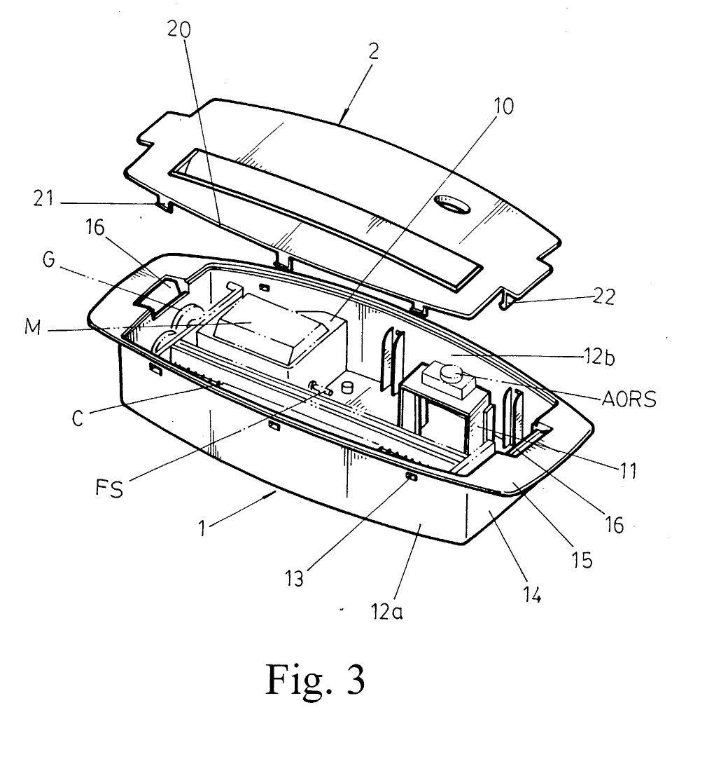

Please refers to FIG. 3, the exploded perspective view of the first embodiment of this invention is illustrated, wherein, a lower box 1 made by plastic injection molding includes a plurality of grooves 10 and pegs 11 for encasing a machinery core, including a motor M, a gear assembly G, cutters C, a feeding switch FS and an auto/off/rev switch AORS etc. The lower box 1 includes a plurality of locating holes 13 formed on a latitudinal front perimeter 12a, a latitudinal rear perimeter 12b, a front or a rear perimeter 12 thereof. A turning part joining the longitudinal perimeter 14 and a handle part of the lower box 1 includes a larger area locating groove 16. A latitudinal perimeter 20 of an upper cover board 2 includes barbed fasteners 21 protruding downwards from a location corresponding to where the locating holes 13 of the lower box 1 are provided. The upper cover board 2 further includes a barbed retaining tab 22 protruding downwards from a location corresponding to where the locating groove 16 of the lower box 1 is provided.

By engaging the fasteners 21 of the upper cover board 2 with the locating holes 13 and locating groove 16 of the lower box 1, the upper cover board 2 is fixed by a convenient covering manner. Because the lower box 1 and the upper cover board 2 are both made by plastic injection molding, when the barbed fasteners 21 and the retaining tab 22 protruding downwards engage with the locating holes 13 and locating groove 16, the flexible feature with the plastic material will result in a better fitting effect.

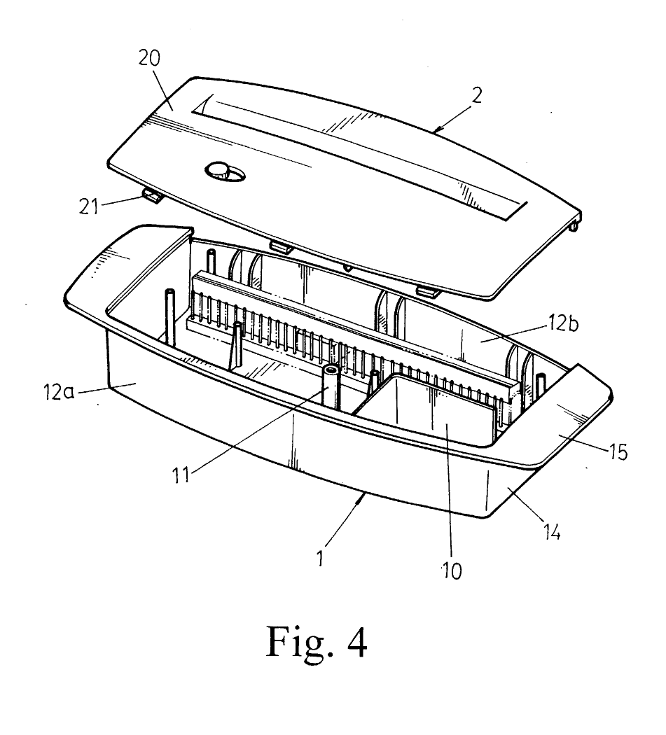

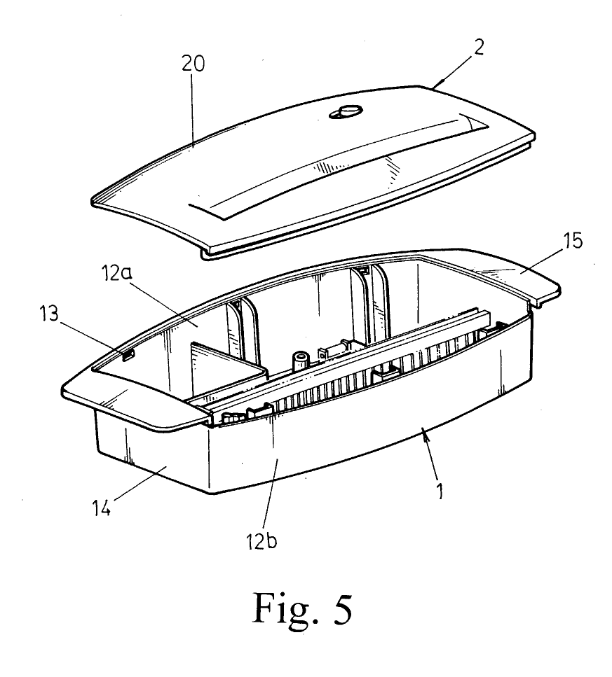

Please refer to FIG. 4 and FIG. 5, the exploded perspective view of second embodiment of the invention is illustrated. The differences between the second embodiment from the first embodiment of this invention reside in that the turning part joining longitudinal the perimeter 14 of the lower box 1 and the handle part 15 is not provided with a locating groove 16. Therefore, the barbed retaining tab 22 of first embodiment provided on the corresponding location of upper cover board 2 is omitted. However, the upper cover board 2 still adopts the covering act of protruding down barbed fastener 21 protruding downwards to engage with the lower box 1 for fixing the upper cover board 2 to the lower box 1.

Whether the first embodiment or second embodiment is adopted depends on the number of paper to be cut by the shredder each time. In other words, a light load shredder that cuts fewer papers each time may adopt the basic cover structure as illustrated and disclosed in the second embodiment. On the contrary, a heavy load shredder that cuts much paper each time must adopt the strengthened cover structure as illustrated and disclosed in the first embodiment to sustain the powerful torque generated during the cutting process of the shredder.

In summary, this invention assembles the upper cover board the lower box by covering the upper cover board over the lower box and by engaging fasteners of the upper cover board with locating holes and locating groove of the lower box to realize the object of simplifying the assembly process and providing convenient maintenance.

What is claimed is:

1. A cover structure for a main case of a shredder, comprising a plastic injection molded lower box and an plastic injection molded upper box board, wherein the lower box defines a plurality of grooves and pegs for encasing a machinery core, including a motor, a gear assembly, cutters, a feeding switch and an auto/off/rev switch AORS, wherein fixing between the lower cover and the upper cover board is achieved by cover a basic fastening structure and/or a strengthened fastening structure.

2. The cover structure for a main case of a shredder according to claim 1, wherein the basic fastening structure comprises: a plurality of locating holes provided on a latitudinal front perimeter, a latitudinal rear perimeter, or front and rear perimeters of the lower box, barbed fasteners protruding down from a latitudinal perimeter of the upper board at locations corresponding to where the location holes of the lower box are provided.

3. The cover structure for a main case of a shredder according to claim 1, wherein the strengthened fastening structure comprises a larger area locating groove provided on a turning part joining a longitudinal perimeter and a handle part of the lower box, a barbed fastening tab protruding down from the upper cover board at a location corresponding to where the location groove of the lower box is provided.

4. The cover structure for a main case of a shredder according to claim 1, wherein the locating groove provided on the turning part joining the longitudinal perimeter and the handle part of the lower box and the strengthened fastening structure including the barbed retaining tab formed on the upper cover board corresponding to the location groove are selectively provided.
